(19) United States
(12) Patent Application Publication
(10) Pub. No.: US 2023/0155457 A1
(43) Pub. Date: May 18, 2023

(54) METHOD OF MANUFACTURING STATOR AND JIG FOR MANUFACTURING STATOR

(71) Applicants: HYUNDAI MOBIS Co., Ltd., Seoul (KR); HAYASHI KOGYOSYO Co., Ltd., Gifu (JP)

(72) Inventors: Yong Ho KIM, Yongin-si (KR); Ko KAJITA, Gifu (JP)

(73) Assignees: HYUNDAI MOBIS Co., Ltd., Seoul (KR); HAYASHI KOGYOSYO Co., Ltd., Gifu (JP)

(21) Appl. No.: 17/987,403

(22) Filed: Nov. 15, 2022

(30) Foreign Application Priority Data
Nov. 16, 2021 (KR) 10-2021-0157549

(51) Int. Cl. H02K 15/02; H02K 15/04

(52) U.S. Cl. CPC H02K 15/026; H02K 15/045

(57) ABSTRACT

Discloses is a method of manufacturing a stator and a jig for manufacturing a stator. An exemplary embodiment of the present disclosure provides a method of manufacturing a stator, the method including a preparation step of preparing a coil material and a stator core having a plurality of slots provided in a circumferential direction C, a winding step of manufacturing a winding coil by winding the coil material, and an insertion step of positioning the winding coil in upper regions of at least some of the plurality of slots and then dropping the winding coil into the slot.

### CROSS-REFERENCE TO RELATED APPLICATION

This application claims priority to and the benefit of Korean Patent Application No. 10-2021-0157549 filed in the Korean Intellectual Property Office on Nov. 16, 2021, and Korean Patent Application No. 10-2021-0157550 filed in the Korean Intellectual Property Office on Nov. 16, 2021, the entire contents of which are incorporated herein by reference.

### TECHNICAL FIELD

The present disclosure relates to a method of manufacturing a stator and a jig for manufacturing a stator, and more particularly, to a method of manufacturing a stator having a winding coil and a jig for manufacturing the stator.

### BACKGROUND ART

A motor configured to convert electrical energy into kinetic energy includes a stator and a rotor. It is necessary to increase a space factor, which refers to a ratio of the volume occupied in a stator core by a coil, in order to improve the efficiency of the motor and reduce a loss of energy occurring on the coil wound around the stator.

However, in the related art, the increase in space factor of a slot causes problems that the coil cannot be properly inserted into the slot or damaged, the performance of the motor deteriorates due to the damage to the coil, or the safety is degraded.

In addition, in the case of a 3-phase motor in the related art, the coil supplied with a particular phase current (e.g., a U-phase current) among the currents with three phases is positioned further inward in the slot of the stator coil than the coil supplied with a current with another phase (e.g., a V-phase current or a W-phase current). For this reason, there is also a problem in that the physical properties of the coils are changed depending on the phases, which degrades the performance of the motor.

### SUMMARY

The present disclosure has been made in an effort to minimize damage to a coil during a process of inserting the coil into a slot of a stator core.

The present disclosure has also been made in an effort to minimize a deviation in physical properties of a coil that occurs depending on phases of provided currents.

An exemplary embodiment of the present disclosure provides a method of manufacturing a stator, the method including: a preparation step of preparing a coil material and a stator core having a plurality of slots arranged in a circumferential direction C; a winding step of manufacturing a winding coil by winding the coil material; and an insertion step of positioning the winding coil in upper regions of at least some of the plurality of slots and then dropping the winding coil into the at least some of the plurality of slots.

In the insertion step, the winding coil may be dropped into the slot by gravity.

A through-hole G may be defined in a central region of the stator core, the plurality of slots may communicate with the through-hole G, and in the insertion step, the winding coil may be positioned in the through-hole G, and then the winding coil may be dropped into the at least some of the plurality of slots.

In the insertion step, the plurality of slots of the stator core may be disposed in a vertical direction, and the winding coil may be moved in a horizontal direction so as to be positioned in the through-hole G.

In the preparation step, the coil material may be prepared to include a first material, and a second material formed separately from the first material, and in the winding step, the winding coil may include a first bundle formed by winding the first material, and a second bundle provided by winding the second material.

In the winding step, the winding coil may include first and second bundles formed by winding the coil material, and the first and second bundles may be integrated by being connected to each other.

In the winding step, the first bundle having a first hole H1 may be formed by winding one end of the first material in a first direction, and the second bundle having a second hole H2 may be formed by winding one end of the second material in a second direction.

In the winding step, the first bundle having a first hole H1 may be formed by winding one end of the coil material in a first direction, and then the second bundle having a second hole H2 may be formed by winding one end of the coil material in a second direction.

In the winding step, the first and second bundles may be spaced apart from each other in a direction in which an imaginary plane extends, the imaginary plane being formed perpendicular to a direction in which the first and second holes H1 and H2 are formed through the first and second bundles.

In the winding step, the first and second bundles may be spaced apart from each other in a direction in which the first and second holes H1 and H2 are formed through the first and second bundles.

In the winding step, the first bundle having a first hole H1 and the second bundle having a second hole H2 may be formed by winding one end and the other end of the coil material in first and second directions, respectively, that are opposite to each other.

Another exemplary embodiment of the present disclosure provides a jig for manufacturing a stator, which is configured to transfer a winding coil and drop the winding coil into a stator core, the jig including: a first region; and a second region coupled to one side of the first region, in which the first region has a first recessed portion recessed upward, and the second region has a second recessed portion recessed upward.

The first and second regions may respectively include: upper portions disposed at upper sides of the first and second regions, respectively; and lower portions disposed at lower sides of the first and second regions and connected to the upper portions, respectively. The first recessed portion may be disposed in a lower surface of the lower portion of the first region, and the second recessed portion may be disposed in a lower surface of the lower portion of the second region.

The first recessed portion may extend to two opposite surfaces of the lower portion of the first region, and the second recessed portion may extend to two opposite surfaces of the lower portion of the second region.

The jig may further include: a third region coupled to one side of the second region; and a fourth region coupled to one side of the third region, the third region may have a third recessed portion recessed upward, and the fourth region may have a fourth recessed portion recessed upward.

The first to fourth regions may be configured to be assembled to one another.

The first to fourth regions may be integrated with each other.

A width of the upper portion may be larger than a width of the lower portion.

The first recessed portion may extend to the upper portion of the first region, and the second recessed portion may extend to the upper portion of the second region.

The jig may have a shape of fan ribs in which a direction in which the first region extends and a direction in which the second region extends define a predetermined angle therebetween, and a direction in which the third region extends and a direction in which the fourth region extends define a predetermined angle therebetween.

The direction in which the second region extends and the direction in which the third region extends may be parallel to each other.

According to the present disclosure, it is possible to minimize damage to the coil during the process of inserting the coil into the slot of the stator core.

In addition, according to the present disclosure, it is possible to minimize a deviation in physical properties of the coil that occurs depending on the phases of provided currents.

### BRIEF DESCRIPTION OF THE DRAWINGS

FIG. 1 is a view illustrating a state before a jig enters a through-hole of a stator core in a method of manufacturing a stator according to the present disclosure.

FIG. 2 is a view illustrating a state after the jig enters the through-hole of the stator core in the method of manufacturing a stator according to the present disclosure.

FIG. 3 is a perspective view illustrating a structure of a jig for manufacturing a stator according to the present disclosure.

FIGS. 4A and 4B are views illustrating a first example of a method of making a winding coil by using a coil material in the method of manufacturing a stator according to the present disclosure.

FIGS. 5A, 5B, and 5C are views illustrating a second example of the method of making a winding coil by using a coil material in the method of manufacturing a stator according to the present disclosure.

FIGS. 6A, 6B, and 6C are views illustrating a third example of the method of making a winding coil by using a coil material in the method of manufacturing a stator according to the present disclosure.

FIG. 7 is a view illustrating a state before a winding coil is inserted into a jig for manufacturing a stator according to one example of the present disclosure.

FIG. 8 is a view illustrating a state after the winding coil is inserted into the jig for manufacturing a stator according to one example of the present disclosure.

FIG. 9 is a view illustrating a state before a winding coil is inserted into a jig for manufacturing a stator according to another example of the present disclosure.

FIG. 10 is a view illustrating a state after the winding coil is inserted into the jig for manufacturing a stator according to another example of the present disclosure.

FIG. 11 is a view illustrating a state in which a winding coil wound by a coil winding jig is inserted into a coil insertion jig in a method of manufacturing a stator according to another example of the present disclosure.

FIG. 12 is a side view illustrating a structure of the coil winding jig according to another example of the present disclosure.

FIG. 13 is a view illustrating a state before the coil insertion jig enters a through-hole of a stator core in the method of manufacturing a stator according to another example of the present disclosure.

FIG. 14 is a view illustrating a state after the coil insertion jig enters the through-hole of the stator core in the method of manufacturing a stator according to another example of the present disclosure.

FIG. 15 is a top plan view illustrating an example of the structure of the coil winding jig according to another example of the present disclosure.

FIG. 16 is a top plan view illustrating another example of the structure of the coil winding jig according to another example of the present disclosure.

FIG. 17 is an enlarged side view of a protruding portion of the coil winding jig according to another example of the present disclosure.

### DETAILED DESCRIPTION

Hereinafter, a method of manufacturing a stator and a jig for manufacturing a stator according to the present disclosure will be described with reference to the drawings.

### Method of Manufacturing Stator

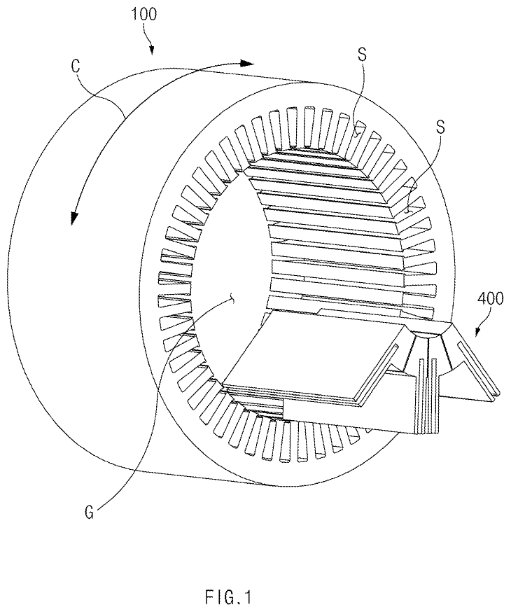

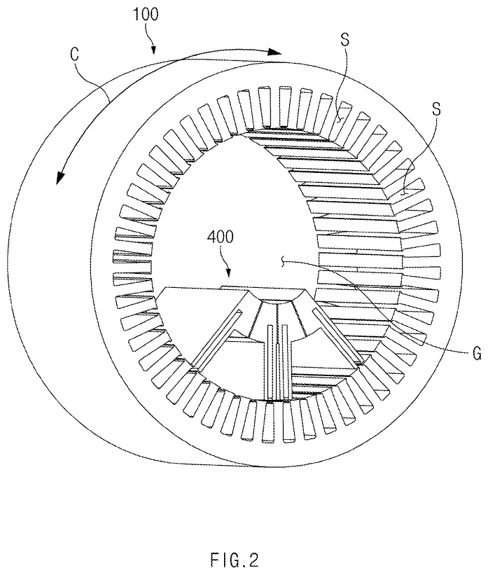

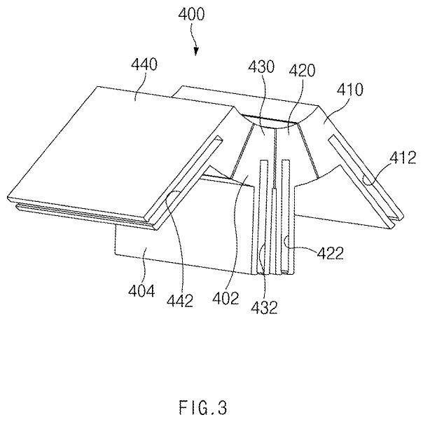

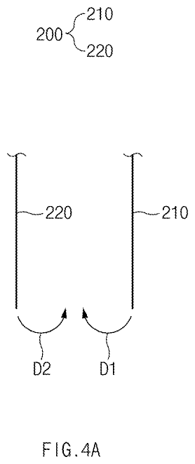

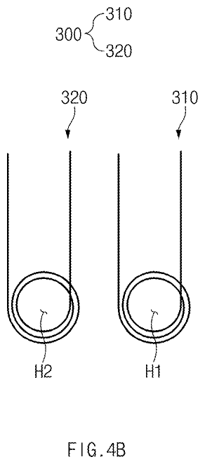

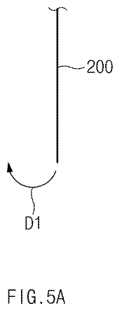

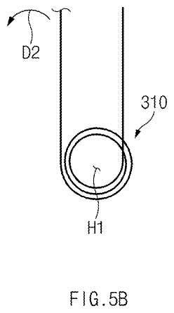

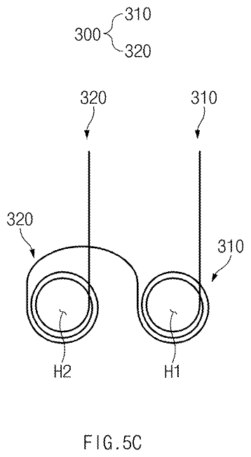

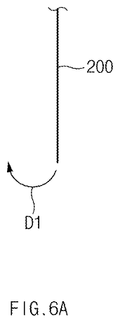

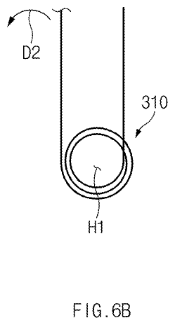

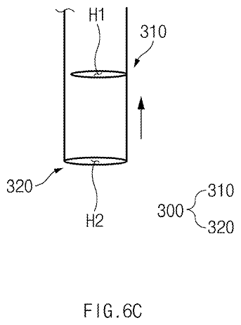

FIG. 1 is a view illustrating a state before a jig enters a through-hole of a stator core in a method of manufacturing a stator according to the present disclosure, and FIG. 2 is a view illustrating a state after the jig enters the through-hole of the stator core in the method of manufacturing a stator according to the present disclosure. FIG. 3 is a perspective view illustrating a structure of a jig for manufacturing a stator according to the present disclosure, and FIGS. 4A and 4B are views illustrating a first example of a method of making a winding coil by using a coil material in the method of manufacturing a stator according to the present disclosure. In addition, FIGS. 5A to 5C are views illustrating a second example of the method of making a winding coil by using a coil material in the method of manufacturing a stator according to the present disclosure, and FIGS. 6A to 6C are views illustrating a third example of the method of making a winding coil by using a coil material in the method of manufacturing a stator according to the present disclosure.

Referring to FIGS. 1 to 6, a method of manufacturing a stator according to the present disclosure may include a preparation step of preparing a coil material 200 and a stator core 100 having a plurality of slots S provided in a circumferential direction C, and a winding step of manufacturing a winding coil 300 by winding the coil material 200. The plurality of slots S provided in the stator core 100 may be spaces into which the winding coil 300 manufactured from the coil material 200 is inserted. The plurality of slots S may be disposed at equal intervals.

In addition, the method of manufacturing a stator may further include an insertion step of positioning the winding coil 300 in upper regions of at least some of the plurality of slots S provided in the stator core 100 and then dropping the winding coil 300 into the slots S.

More specifically, in the insertion step, the winding coil 300 may be dropped in a direction perpendicular to the ground surface and dropped into the slots S by gravity. That is, according to the present disclosure, in the insertion step, the winding coil 300 may be inserted into the slots S without receiving separate external power. Therefore, according to the present disclosure, it is possible to prevent the winding coil 300 from being damaged during the process of inserting the winding coil 300 into the slots S of the stator core 100.

More specifically, a through-hole G may be provided in a central region of the stator core 100, and the plurality of slots S may communicate with the through-hole G. In this case, in the insertion step of the method of manufacturing a stator according to the present disclosure, the winding coil 300 may be positioned in the through-hole G, and then the winding coil 300 may be dropped into the slots S. That is, referring to FIGS. 1 and 2, a jig 400 into which the winding coil 300 (see FIGS. 4 to 6) is inserted may be positioned outside the through-hole G before the insertion step as illustrated in FIG. 1, and then the jig 400 into which the winding coil 300 (see FIGS. 4 to 6) is inserted may be positioned inside the through-hole G as illustrated in FIG. 2 in the insertion step.

More particularly, in the insertion step, the jig 400 and the winding coil 300 may move in parallel with the ground surface. To this end, as illustrated in FIGS. 1 and 2, in the insertion step, the plurality of slots S of the stator core 100 may be disposed in a vertical direction, and the winding coil 300 may be moved in a horizontal direction and positioned in the through-hole G.

Meanwhile, referring to FIGS. 4A and 4B, according to the first example of the present disclosure, in the preparation step, the coil material 200 may include a first material 210, and a second material 220 provided separately from the first material 210. In addition, in the winding step, the winding coil 300 may include a first bundle 310 made by winding the first material 210, and a second bundle 320 made by winding the second material 220.

More specifically, according to the first example of the present disclosure, in the winding step, the first bundle 310 having a first hole H1 may be made by winding one end of the first material 210 in a first direction D1 (e.g., clockwise), and the second bundle 320 having a second hole H2 may be made by winding one end of the second material 220 in a second direction D2 (e.g., counterclockwise). FIG. 4 illustrates an example in which a lower end of the first material 210 and a lower end of the second material 220 are wound in the winding step.

In contrast, referring to FIGS. 5A to 5C and 6A to 6C, according to the second and third examples of the present disclosure, in the winding step, the winding coil 300 may include the first and second bundles 310 and 320 made by winding the coil material 200, and the first and second bundles 310 and 320 are integrated by being connected to each other. That is, according to the second and third examples of the present disclosure, the winding coil 300 including the first and second bundles 310 and 320 may be manufactured by using the single coil material 200.

In this case, referring to FIGS. 5A to 5C and 6A to 6C, according to the second and third examples of the present disclosure, in the winding step, the first bundle 310 having the first hole H1 may be made by winding one end of the coil material 200 in the first direction D1 (e.g., clockwise), and then the second bundle 320 having the second hole H2 may be made by winding one end of the coil material 200 in the second direction D2 (e.g., counterclockwise). FIGS. 5A to 5C and 6A to 6C illustrate an example in which in the winding step, the first bundle 310 having the first hole H1 is made by winding a lower end of the coil material 200, and the second bundle 320 having the second hole H2 is made by winding an upper end of the coil material 200.

More specifically, referring to FIGS. 5A to 5C and 6A to 6C, according to the second and third examples of the present disclosure, in the winding step, i) the first bundle 310 having the first hole H1 may be provided by winding one end of the coil material 200 in the first direction D1 (e.g., clockwise), ii) one end of the coil material 200 may be extended in one direction, and then iii) the second bundle 320 having the second hole H2 may be provided by winding one end of the coil material 200 in the second direction D2 (e.g., counterclockwise). That is, according to the second and third examples of the present disclosure, the timing of forming the first bundle 310 and the timing of forming the second bundle 320 may be different from each other in a time series manner.

In this case, as illustrated in FIGS. 5A to 5C, according to the second example of the present disclosure, in the winding step, the first and second bundles 310 and 320 may be spaced apart from each other in a direction in which an imaginary plane (i.e., a plane including the drawing based on FIG. 5) extends, the imaginary plane being formed perpendicular to a direction in which the first and second holes H1 and H2 are formed through the first and second bundles 310 and 320 (i.e., a direction perpendicular to the drawing based on FIG. 5).

In contrast, as illustrated in FIGS. 6A to 6C, according to the third example of the present disclosure, in the winding step, the first and second bundles 310 and 320 may be spaced apart from each other in the direction in which the first and second holes H1 and H2 are formed through the first and second bundles 310 and 320 (i.e., in an upward/downward direction based on FIG. 6C). To this end, according to the third example of the present disclosure, in the winding step, the first bundle 310 may be moved by a predetermined distance, in the direction in which the first hole H1 is formed through the first bundle 310, before the second bundle 320 is manufactured after the first bundle 310 is manufactured.

In contrast, according to the fourth example of the present disclosure, the timings of forming the first and second bundles 310 and 320 formed in one coil material 200 may overlap each other in a time series manner, unlike the second and third examples of the present disclosure. For example, according to the fourth example of the present disclosure, in the winding step, the first bundle 310 having the first hole H1 and the second bundle 320 having the second hole H2 may be provided by winding one end and the other end of the coil material 200 in opposite directions, i.e., the first direction (e.g., clockwise) and the second direction (e.g., counterclockwise). In this case, the timing of winding one end of the coil material 200 and the timing of winding the other end of the coil material 200 may overlap each other in a time series manner.

Meanwhile, the method of manufacturing a stator according to the present disclosure may further include, after the insertion step, a forming step of forming and processing ends of the winding coil and a connection step of connecting the winding coils.

### Jig for Manufacturing Stator

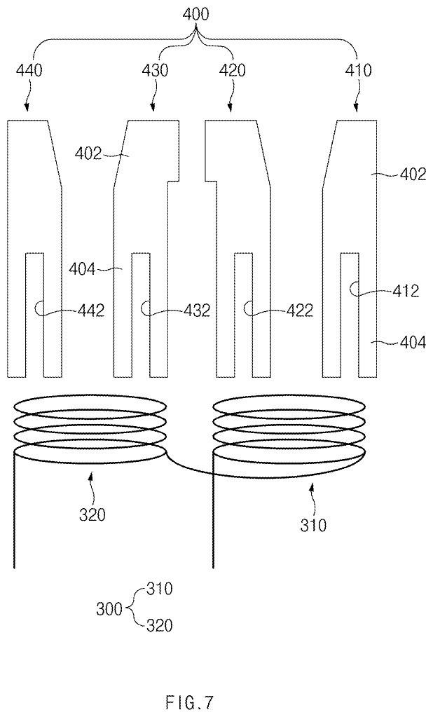

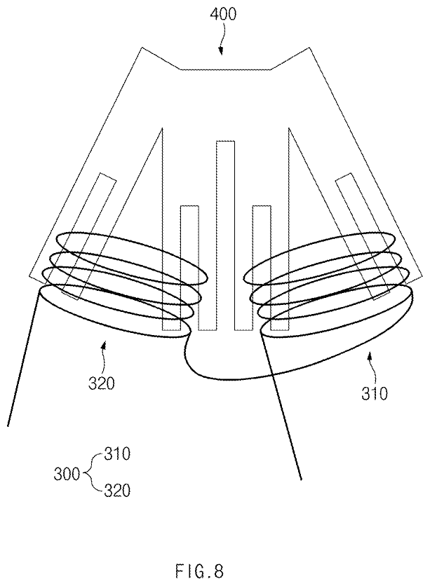

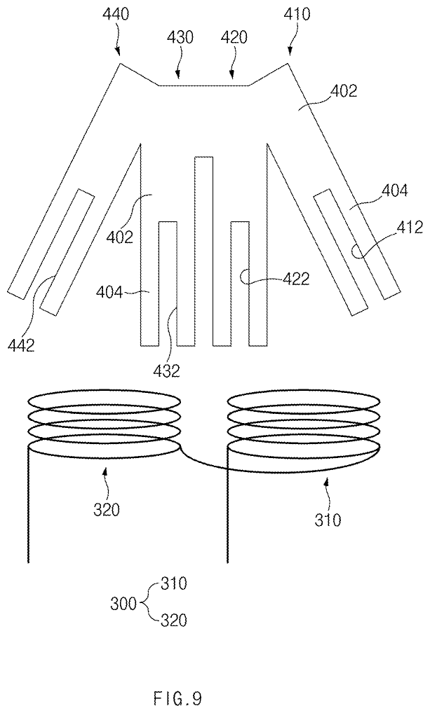

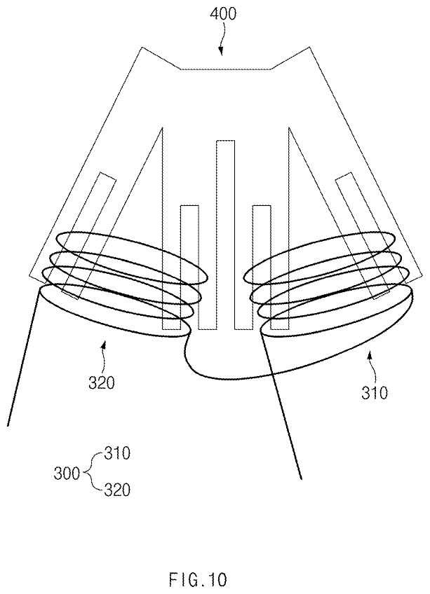

FIG. 7 is a view illustrating a state before a winding coil is inserted into a jig for manufacturing a stator according to one example of the present disclosure, and FIG. 8 is a view illustrating a state after the winding coil is inserted into the jig for manufacturing a stator according to one example of the present disclosure. In addition, FIG. 9 is a view illustrating a state before a winding coil is inserted into a jig for manufacturing a stator according to another example of the present disclosure, and FIG. 10 is a view illustrating a state after the winding coil is inserted into the jig for manufacturing a stator according to another example of the present disclosure.

Referring to FIGS. 7 to 10, the jig 400 for manufacturing a stator (hereinafter, referred to as a ‘jig’) according to the present disclosure may be a jig configured to transfer the winding coil 300 (see FIGS. 1 to 6) and drop the winding coil into the stator core 100 (see FIGS. 1 to 6).

More specifically, the jig 400 may include a first region 410, a second region 420 coupled to one side of the first region 410, a third region 430 coupled to one side of the second region 420, and a fourth region 440 coupled to one side of the third region 430.

In this case, according to the present disclosure, the first region 410 may have a first recessed portion 412 recessed upward, the second region 420 may have a second recessed portion 422 recessed upward, the third region 430 may have a third recessed portion 432 recessed upward, and the fourth region 440 may have a fourth recessed portion 442 recessed upward.

More specifically, the first to fourth regions 410, 420, 430, and 440 may each include an upper portion 402 provided at an upper side of each of the first to fourth regions 410, 420, 430, and 440, and a lower portion 404 provided at a lower side of each of the first to fourth regions 410, 420, 430, and 440 and connected to the upper portion 402. In this case, the first recessed portion 412 may be formed in a lower surface of the lower portion 404 of the first region 410, the second recessed portion 422 may be formed in a lower surface of the lower portion 404 of the second region 420, the third recessed portion 432 may be formed in a lower surface of the lower portion 404 of the third region 430, and the fourth recessed portion 442 may be formed in a lower surface of the lower portion 404 of the fourth region 440.

In addition, the first recessed portion 412 may extend to two opposite surfaces of the lower portion 404 of the first region 410, the second recessed portion 422 may extend to two opposite surfaces of the lower portion 404 of the second region 420, the third recessed portion 432 may extend to two opposite surfaces of the lower portion 404 of the third region 430, and the fourth recessed portion 442 may extend to two opposite surfaces of the lower portion 404 of the fourth region 440.

Meanwhile, referring to FIG. 3, a width of the upper portion 402 of each of the first to fourth regions 410, 420, 430, and 440 may be larger than a width of the lower portion 404 thereof. In this case, the first recessed portion 412 may extend to the upper portion 402 of the first region 410, the second recessed portion 422 may extend to the upper portion 402 of the second region 420, the third recessed portion 432 may extend to the upper portion 402 of the third region 430, and the fourth recessed portion 442 may extend to the upper portion 402 of the fourth region 440. In contrast, as illustrated in FIGS. 7 to 8, a width of the upper portion 402 of each of the first to fourth regions 410, 420, 430, and 440 may be equal to a width of the lower portion 404 thereof.

In addition, the jig 400 according to the present disclosure may have a shape of fan ribs in which a direction in which the first region 410 extends and a direction in which the second region 420 extends define a predetermined angle therebetween, and a direction in which the third region 430 extends and a direction in which the fourth region 440 extends define a predetermined angle therebetween. In contrast, the direction in which the second region 420 extends and the direction in which the third region 430 extends may be parallel to each other. More particularly, the second region 420 and the third region 430 may extend downward. Therefore, the second recessed portion 422 and the third recessed portion 432 may extend upward in a direction perpendicular to the ground surface. The first recessed portion 412 and the fourth recessed portion 442 may extend upward while being inclined at a predetermined angle with respect to the ground surface.

Meanwhile, referring to FIGS. 7 and 8, the jig 400 according to the present disclosure may be assembled. More specifically, the first to fourth regions 410, 420, 430, and 440 may be assembled to one another. However, referring to FIGS. 9 and 10, the first to fourth regions 410, 420, 430, and 440 of the jig 400 according to the present disclosure may be integrated.

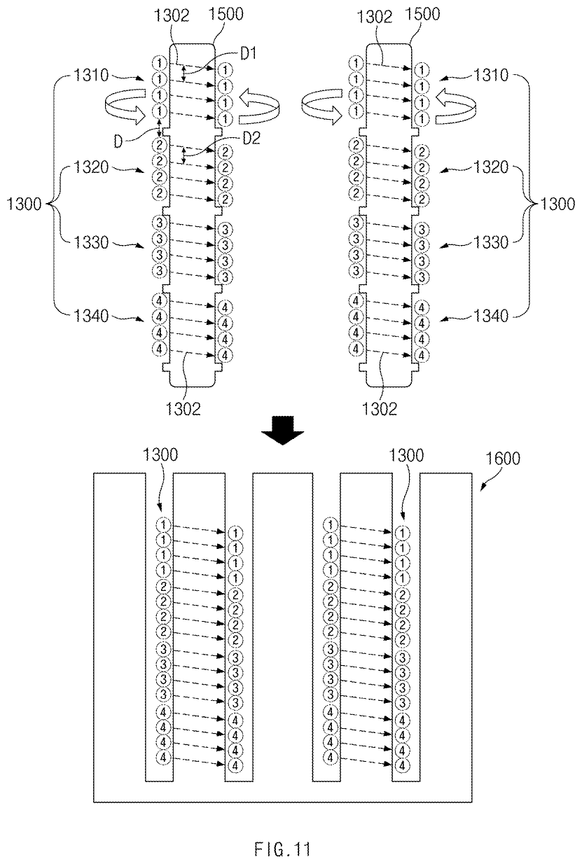

Hereinafter, a method of manufacturing a stator and a coil winding jig according to another example of the present disclosure will be described with reference to FIGS. 11 to 17.

### Method of Manufacturing Stator

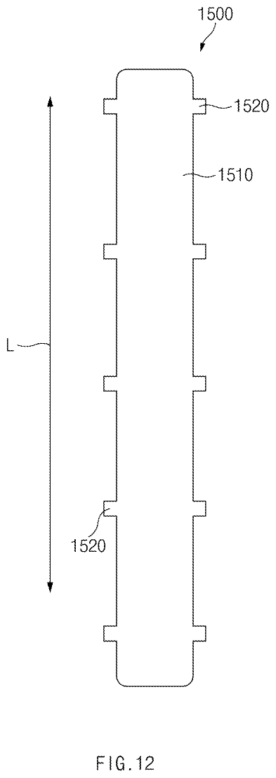

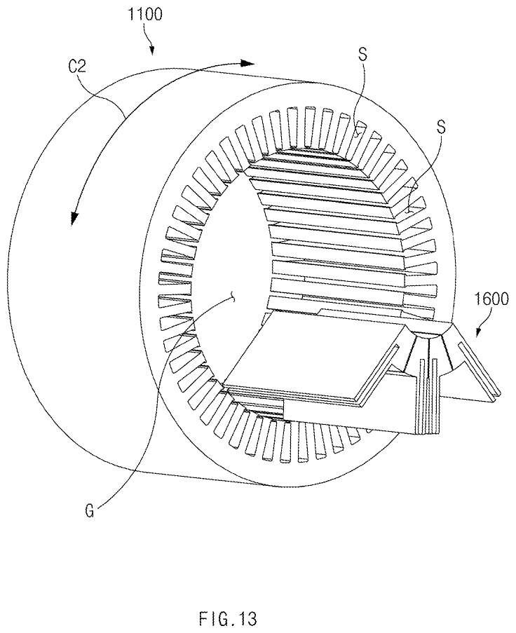

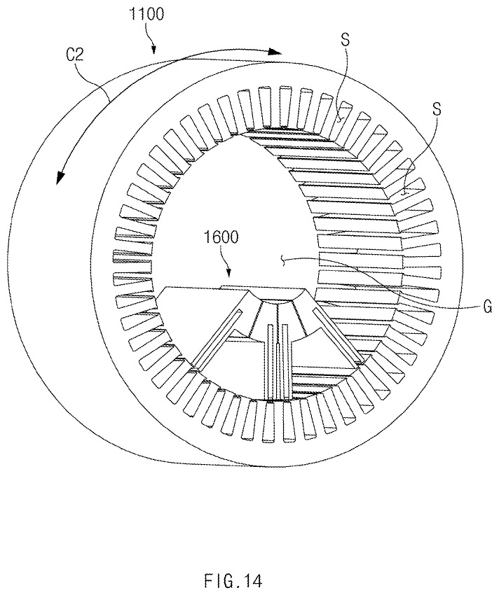

FIG. 11 is a view illustrating a state in which a winding coil wound by a coil winding jig is inserted into a coil insertion jig in a method of manufacturing a stator according to the present disclosure, and FIG. 12 is a side view illustrating a structure of the coil winding jig according to the present disclosure. FIG. 13 is a view illustrating a state before the coil insertion jig enters a through-hole of a stator core in the method of manufacturing a stator according to the present disclosure, and FIG. 14 is a view illustrating a state after the coil insertion jig enters the through-hole of the stator core in the method of manufacturing a stator according to the present disclosure.

Referring to FIGS. 11 to 14, a method of manufacturing a stator according to the present disclosure may include a preparation step of preparing a coil material and a stator core 1100 having a plurality of slots S provided in a circumferential direction C2, and a winding step of manufacturing a winding coil by winding the coil material. The plurality of slots S provided in the stator core 1100 may be spaces into which the winding coil 1300 manufactured from the coil material is inserted. The plurality of slots S may be disposed at equal intervals.

In addition, the method of manufacturing a stator according to the present disclosure may further include an insertion step of inserting the winding coil 1300 manufactured in the winding step into a coil insertion jig 1600, and a dropping step of moving the coil insertion jig 1600 so that the winding coil 1300 is positioned in upper regions of at least some of the plurality of slots S and then dropping the winding coil 1300 into the slots S.

More specifically, in the dropping step, the winding coil 1300 may be dropped in a direction perpendicular to the ground surface and dropped into the slots S by gravity. That is, according to the present disclosure, in the dropping step, the winding coil 1300 may be inserted into the slots S without receiving separate external power. Therefore, according to the present disclosure, it is possible to prevent the winding coil 1300 from being damaged during the process of inserting the winding coil 1300 into the slots S of the stator core 1100.

More specifically, a through-hole G may be provided in a central region of the stator core 1100, and the plurality of slots S may communicate with the through-hole G. In this case, in the dropping step of the method of manufacturing a stator according to the present disclosure, the coil insertion jig 1600 may be moved so that the winding coil 1300 is positioned in the through-hole G, and then the winding coil 1300 may be dropped into the slots S. That is, referring to FIGS. 13 and 14, the coil insertion jig 1600 into which the winding coil 1300 (see FIG. 11) is inserted may be positioned outside the through-hole G before the dropping step, and then the coil insertion jig 1600 into which the winding coil 1300 (see FIG. 11) is inserted may be positioned inside the through-hole G in the dropping step.

More particularly, in the dropping step, the coil insertion jig 1600 and the winding coil 1300 may move in parallel with the ground surface. To this end, as illustrated in FIGS. 13 and 14, in the dropping step, the plurality of slots S of the stator core 1100 may be disposed in a vertical direction, and the winding coil 1300 (see FIG. 11) may be moved in a horizontal direction and positioned in the through-hole G.

Meanwhile, referring to FIG. 11, in the winding step of the method of manufacturing a stator according to the present disclosure, the winding coil 1300 may have first and second bundles 1310 and 1320 made by winding the coil material. In this case, the first and second bundles 1310 and 1320 may each include a plurality of winding regions 1302 spaced apart from one another in a direction (i.e., an upward/downward direction based on FIG. 11) intersecting a direction (i.e., a leftward/rightward direction based on FIG. 11) in which the winding coil 1300 extends. An interval D between the first bundle 1310 and the second bundle 1320 may be larger than an interval D1 between the plurality of winding regions 1302 in the first bundle 1310 and an interval D2 between the plurality of winding regions 1302 in the second bundle 1320. FIG. 11 illustrates that in the winding step, the winding coil 1300 has third and fourth bundles 1330 and 1340 in addition to the first and second bundles 1310 and 1320.

In this case, an interval between the second bundle 1320 and the third bundle 1330 may be larger than the interval between the plurality of winding regions 1302 in the second bundle 1320 and an interval between a plurality of winding regions 1302 in the third bundle 1330. In addition, an interval between the third bundle 1330 and the fourth bundle 1340 may be larger than the interval between the plurality of winding regions 1302 in the third bundle 1330 and an interval between a plurality of winding regions 1302 in the fourth bundle 1340.

According to the present disclosure, the state in which the bundles 1310, 1320, 1330, and 1340 of the winding coil 1300 manufactured by using the coil material are spaced apart from one another may be maintained. Therefore, it is possible to prevent the bundles 1310, 1320, 1330, and 1340 from being entangled during the process of inserting the winding coil 1300 into the slots S of the stator core 1100. Therefore, it is possible to minimize the occurrence of dead space in the slots S of the stator core 1100 that does not contribute to the performance. Therefore, it is possible to improve the space factor.

More specifically, according to the present disclosure, in the winding step, the coil material may be disposed on one surface of a coil winding jig 1500 having a shape extending in a longitudinal direction L of a shaft 1510, and then the coil winding jig 1500 may be rotated about the shaft 1510 as a rotation axis, such that the winding coil 1300 may be manufactured. Further, the first and second bundles 1310 and 1320 may be spaced apart from one another with protruding portions 1520 (see FIG. 12) interposed therebetween, the protruding portions 1520 being formed on the surface of the shaft 1510. Similarly, the second bundle 1320 and the third bundle 1330 may also be spaced apart from one another with the protruding portions interposed therebetween, the protruding portions being formed on the surface of the shaft 1510. The third bundle 1330 and the fourth bundle 1340 may also be spaced apart from one another with the protruding portions interposed therebetween, the protruding portions being formed on the surface of the shaft 1510.

Meanwhile, according to the present disclosure, in the winding step, a lower region of the winding coil may be formed after an upper region of the winding coil is formed. In addition, the first bundle 1310 may be formed after the second bundle 1320 is formed. The second bundle 1320 may be formed after the third bundle 1330 is formed. The third bundle 1330 may be formed after the fourth bundle 1340 is formed. Therefore, according to the present disclosure, the first bundle 1310 may be disposed closer to the top side than is the second bundle 1320. The second bundle 1320 may be disposed closer to the top side than is the third bundle 1330. The third bundle 1330 may be disposed closer to the top side than is the fourth bundle 1340.

### Coil Winding Jig

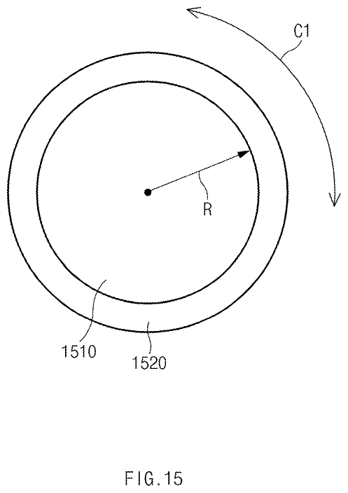

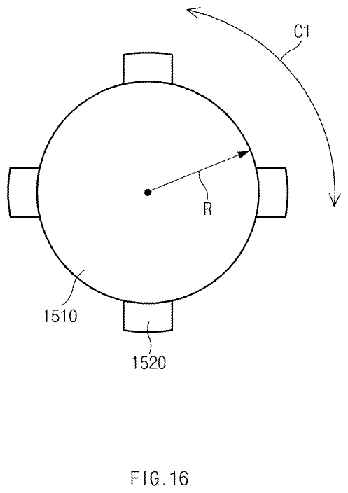

FIG. 15 is a top plan view illustrating an example of the structure of the coil winding jig according to another example of the present disclosure, and FIG. 16 is a top plan view illustrating another example of the structure of the coil winding jig according to another example of the present disclosure.

Referring to FIGS. 11, 12, 15, and 16, the coil winding jig 1500 according to the present disclosure may include the shaft 1510 configured to define a body of the jig, a power supply unit (not illustrated) configured to provide power for rotating the shaft 1510, and the protruding portions 1520 formed on the surface of the shaft 1510 and protruding outward. As described above, the protruding portions 1520 may be configured to allow the bundles of the winding coil 1300 to be spaced apart from one another.

Referring to FIGS. 15 and 16, the shaft 1510 may have a rod structure having a circular cross-section. However, the shaft 1510 may have a rod structure having an elliptical cross-section.

Meanwhile, as illustrated in FIG. 15, according to the example of the present disclosure, the protruding portion 1520 may have a shape of a closed curve extending in a circumferential direction C1 of the shaft 1510. However, as illustrated in FIG. 16, according to another example of the present disclosure, the protruding portion 1520 may have a shape of an open curve extending in the circumferential direction C1 of the shaft 1510. FIG. 16 illustrates an example in which four protruding portions 1520 each having a shape of an open curve are disposed in the circumferential direction C1 of the shaft 1510, and the four protruding portions 1520 are disposed at equal intervals.

In addition, referring to FIG. 12, the protruding portion 1520 may be provided in plural, and the plurality of protruding portions 1520 may be spaced apart from one another in the longitudinal direction L of the shaft 1510. FIG. 12 illustrates an example in which five protruding portions 1520 are disposed at equal intervals in the longitudinal direction L of the shaft 1510.

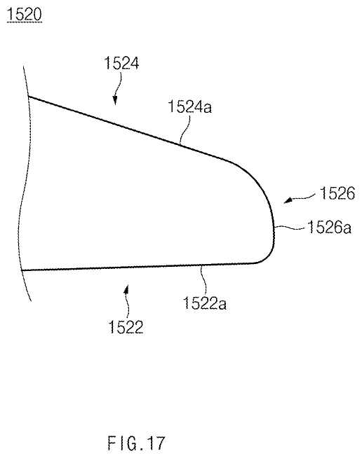

FIG. 17 is an enlarged side view of the protruding portion of the coil winding jig according to another example of the present disclosure.

Meanwhile, as illustrated in FIGS. 12 and 17, the protruding portion 1520 provided on the coil winding jig 1500 according to the present disclosure may include a lower surface 1522 directed downward, and an upper surface 1524 directed upward. In this case, the upper surface 1524 may include an inclined section 1524a inclined downward toward the outside in a radial direction R of the shaft 1510. The lower surface 1522 may include a horizontal section 1522a extending horizontally in the radial direction R of the shaft 1510.

According to the present disclosure, because the upper surface 1524 has the inclined section 1524a, the winding coil 1300 may easily slide along the inclined section 1524a when the winding coil 1300 is dropped from the coil winding jig 1500 so that the winding coil 1300 is inserted into the coil insertion jig 1600 in the insertion step. Therefore, the winding coil 1300 may be smoothly inserted into the coil insertion jig 1600. In contrast, according to the present disclosure, because the lower surface 1522 has the horizontal section 1522a, it is possible to effectively prevent the lower region (e.g., second bundle) of the winding coil 1300 from being moved upward toward the upper region (e.g., first bundle) of the winding coil 1300.

Referring to FIG. 17, the protruding portion 1520 may further include a lateral surface 1526 provided at an outer end based on the radial direction R and configured to connect the inclined section 1524a and the horizontal section 1522a. In this case, the lateral surface 1526 may include a curved surface section 1526a having a convex shape.

According to the present disclosure, because the lateral surface 1526 has the curved surface section 1526a, it is possible to prevent the winding coil 1300 from being damaged by the protruding portion 1520 during the process in which the winding coil 1300 passes over the protruding portion 1520 in the insertion step.

The present disclosure has been described with reference to the limited embodiments and the drawings, but the present disclosure is not limited thereto. The present disclosure may be carried out in various forms by those skilled in the art, to which the present disclosure pertains, within the technical spirit of the present disclosure and the scope equivalent to the appended claims.

What is claimed is:

1. A method of manufacturing a stator, the method comprising:
a preparation step of preparing a coil material and a stator core having a plurality of slots arranged in a circumferential direction C;
a winding step of manufacturing a winding coil by winding the coil material; and
an insertion step of positioning the winding coil in upper regions of at least some of the plurality of slots and then dropping the winding coil into the at least some of the plurality of slots.

2. The method of claim 1, wherein in the insertion step, the winding coil is dropped into the slot by gravity.

3. The method of claim 1, wherein a through-hole G is defined in a central region of the stator core, and the plurality of slots communicates with the through-hole G, and
wherein in the insertion step, the winding coil is positioned in the through-hole G, and then the winding coil is dropped into the at least some of the plurality of slots.

4. The method of claim 3, wherein in the insertion step, the plurality of slots of the stator core is disposed in a vertical direction, and the winding coil is moved in a horizontal direction so as to be positioned in the through-hole G.

5. The method of claim 1, wherein in the preparation step, the coil material is prepared to include a first material, and a second material provided separately from the first material, and
wherein in the winding step, the winding coil includes a first bundle formed by winding the first material, and a second bundle formed by winding the second material.

6. The method of claim 1, wherein in the winding step, the winding coil includes first and second bundles formed by winding the coil material, and the first and second bundles are integrated by being connected to each other.

7. The method of claim 5, wherein in the winding step, the first bundle having a first hole H1 is formed by winding one end of the first material in a first direction, and the second bundle having a second hole H2 is formed by winding one end of the second material in a second direction.

8. The method of claim 6, wherein in the winding step, the first bundle having a first hole H1 is formed by winding one end of the coil material in a first direction, and then the second bundle having a second hole H2 is formed by winding one end of the coil material in a second direction.

9. The method of claim 8, wherein in the winding step, the first and second bundles are spaced apart from each other in a direction in which perpendicular to a direction in which the first and second holes H1 and H2 are formed through the first and second bundles.

10. The method of claim 8, wherein in the winding step, the first and second bundles are spaced apart from each other in a direction in which the first and second holes H1 and H2 are formed through the first and second bundles.

11. The method of claim 6, wherein in the winding step, the first bundle having a first hole H1 and the second bundle having a second hole H2 are formed by winding one end and the other end of the coil material in first and second directions, respectively, that are opposite to each other.

12. A jig for manufacturing a stator, which is configured to transfer a winding coil and drop the winding coil into a stator core, the jig comprising:
a first region; and
a second region coupled to one side of the first region,
wherein the first region has a first recessed portion recessed upward, and the second region has a second recessed portion recessed upward.

13. The jig of claim 12, wherein the first and second regions respectively comprise:
upper portions disposed at upper sides of the first and second regions, respectively; and
lower portions disposed at lower sides of the first and second regions and connected to the upper portions, respectively, and
wherein the first recessed portion is disposed in a lower surface of the lower portion of the first region, and the second recessed portion is disposed in a lower surface of the lower portion of the second region.

14. The jig of claim 13, wherein the first recessed portion extends to two opposite surfaces of the lower portion of the first region, and the second recessed portion extends to two opposite surfaces of the lower portion of the second region.

15. The jig of claim 12, further comprising:
a third region coupled to one side of the second region; and
a fourth region coupled to one side of the third region,
wherein the third region has a third recessed portion recessed upward, and the fourth region has a fourth recessed portion recessed upward.

16. The jig of claim 15, wherein the first to fourth regions are configured to be assembled to one another.

17. The jig of claim 15, wherein the first to fourth regions are integrated with each other.

18. The jig of claim 13, wherein a width of the upper portion is larger than a width of the lower portion.

19. The jig of claim 18, wherein the first recessed portion extends to the upper portion of the first region, and the second recessed portion extends to the upper portion of the second region.

20. The jig of claim 15, wherein the jig has a shape of fan ribs in which a direction in which the first region extends and a direction in which the second region extends define a predetermined angle therebetween, and a direction in which the third region extends and a direction in which the fourth region extends define a predetermined angle therebetween.
